(19) United States
(12) Patent Application Publication
(10) Pub. No.: US 2026/0241940 A1
(43) Pub. Date: Aug. 20, 2026

(54) System and Methods for Remapping Driving Scenarios for Training Autonomous Vehicles

(71) Applicant: dRISK, Inc., Pasadena, CA (US)

(72) Inventors: Hugh BLAYNEY, Merstham, Surrey (GB); Hamish SCOTT, Gloucestershire (GB); Federico Arenas LÓPEZ, London (GB); Robert Chess STETSON, Altadena, CA (US)

(73) Assignee: dRISK, Inc., Pasadena, CA (US)

(21) Appl. No.: 19/489,552

(22) PCT Filed: Jun. 3, 2024
(86) PCT No.: PCT/US2024/032276

§ 371 Date: Dec. 2, 2025

Related U.S. Application Data
(60) Provisional application No. 63/506,019, filed on Jun. 2, 2023.

(51) Int. Cl. B60W 50/00; B60W 40/04; B60W 40/10; B60W 60/00; G06N 20/00

(52) U.S. Cl. CPC B60W 50/0097; B60W 40/04; B60W 40/10; B60W 60/0027; G06N 20/00; B60W 2050/0031; B60W 2556/40

(57) ABSTRACT

Systems and methods for remapping driving scenarios for training autonomous vehicles in accordance with embodiments of the invention are illustrated. One embodiment includes a method for training an autonomous vehicle control system, including obtaining a driving scenario, where the scenario describes at least a given vehicle trajectory on a given road network, generating a semantic representation of the given road network as a lane graph, calculating a path of the given vehicle through the lane graph, searching for subgraph isomorphisms from the path to a target lane graph, where the target lane graph represents a target network having a different layout than the given road network, mapping the path to the target lane graph using the identified subgraph isomorphisms, reconstructing at least one remapped scenario using the mapped paths, and training an autonomous vehicle control model using the at least one remapped scenario.

### CROSS-REFERENCE TO RELATED APPLICATIONS

The current application claims the benefit of and priority under 35 U.S.C. §119(e) to U.S. Provisional Patent Application No. 63/506,019 entitled “System and Methods for Remapping Driving Scenarios for Autonomous Vehicles” filed Jun. 2, 2023. The disclosure of U.S. Provisional Patent Application No. 63/506,019 is hereby incorporated by reference in its entirety for all purposes.

### FIELD OF THE INVENTION

The present invention generally relates to the generation of training data for autonomous vehicle control systems, namely the generation of remapped, synthetic scenarios to enable higher quality machine learning model training.

### BACKGROUND

Neural networks are a class of machine learning technique which is often utilized for “artificial intelligence” tasks. Neural networks utilize a set of artificial neurons (or “nodes”) which are linked, often in different sets of layers. Neural networks can be trained by providing a set of training data that provides a matched set of inputs and desired outputs. Neural networks can change the weights of connections between its nodes. A successfully trained neural network is capable of outputting a desired output based on an input sufficiently similar to the training data.

Autonomous vehicles (AVs) are vehicles (e.g. cars, trucks, boats, trains, etc.) that are capable of sensing their environment and safely navigating it with little or no human input. Autonomous cars are often referred to as “self-driving cars”, and the autonomous navigation feature is often referred to as “auto pilot”. Autonomy in vehicles is often categorized in six levels according to SAE standard J3016 which roughly defines said levels as: Level 0—no automation; Level 1—hands on/shared control; Level 2—hands off; Level 3—eyes off; Level 4—mind off; and Level 5—steering wheel optional. AVs are often characterized as having perception and controls subsystems, where the perception subsystem transforms sensory input into an internal representation of actors and obstacles in the outside world which must be navigated, and the controls subsystem decides on an appropriate navigation and generates throttle, braking and steering commands that executes that navigation.

### SUMMARY OF THE INVENTION

Systems and methods for remapping driving scenarios for training autonomous vehicles in accordance with embodiments of the invention are illustrated. One embodiment includes a method for training an autonomous vehicle control system, including obtaining a driving scenario, where the scenario describes at least a given vehicle trajectory on a given road network, generating a semantic representation of the given road network as a lane graph, calculating a path of the given vehicle through the lane graph, searching for subgraph isomorphisms from the path to a target lane graph, where the target lane graph represents a target network having a different layout than the given road network, mapping the path to the target lane graph using the identified subgraph isomorphisms, reconstructing at least one remapped scenario using the mapped paths, and training an autonomous vehicle control model using the at least one remapped scenario.

In a further embodiment, the scenario further describes trajectories of entities other than the given vehicle on the road network, and the method further includes calculating a path for each of the entities through the lane graph, searching for subgraph isomorphisms to the target lane graph from the paths of the entities, mapping the paths of the entities to their respective subgraph isomorphisms, and reconstructing the at least one remapped scenario using the respective subgraph isomorphisms.

In still another embodiment, the method further includes steps for combining one or more of the paths of the entities and the path of the given vehicle via connected components.

In a still further embodiment, the lane graph is a heterogenous graph includes several nodes in a coordinate system connected by several edges, and the given vehicle trajectory is represented as a collection of (x, y) coordinate pairs in the coordinate system, and wherein to calculate the path of the given vehicle, the method further includes converting each (x, y) coordinate pair to a (l, r, θ) coordinate triple.

In yet another embodiment, reconstructing the at least one remapped scenario includes converting each (l, r, θ) coordinate triple to an (x, y) coordinate pair in the target lane graph.

In a yet further embodiment, the method further includes steps for filtering the at least one remapped scenario to only include remapped scenarios where geometric values are held consistent with respect to the driving scenario.

In another additional embodiment, the search for subgraph isomorphisms further includes searching for approximate subgraph isomorphisms.

In a further additional embodiment, the method further includes steps for encoding the at least one remapped scenario into a manifold, and training the autonomous vehicle control model includes providing the manifold to the autonomous vehicle control model.

In another embodiment again, the method further includes steps for loading the trained autonomous vehicle control model to an autonomous vehicle.

One embodiment includes an autonomous vehicle control system, including a machine learning model trained using synthetic training data, where at least a portion of the synthetic training data is generated by obtaining a driving scenario, where the scenario describes at least a given vehicle trajectory on a given road network, generating a semantic representation of the given road network as a lane graph, calculating a path of the given vehicle through the lane graph, searching for subgraph isomorphisms from the path to a target lane graph, where the target lane graph represents a target network having a different layout than the given road network, mapping the path to the target lane graph using the identified subgraph isomorphisms, reconstructing at least one remapped scenario using the mapped paths.

In a further embodiment again, the scenario further describes trajectories of entities other than the given vehicle on the road network, and the training data is further generated by calculating a path for each of the entities through the lane graph, searching for subgraph isomorphisms to the target lane graph from the paths of the entities, mapping the paths of the entities to their respective subgraph isomorphisms, and reconstructing the at least one remapped scenario using the respective subgraph isomorphisms.

In still yet another embodiment, the autonomous vehicle control system further includes steps for combining one or more of the paths of the entities and the path of the given vehicle via connected components.

In a still yet further embodiment, the lane graph is a heterogenous graph includes several nodes in a coordinate system connected by several edges, and the given vehicle trajectory is represented as a collection of (x, y) coordinate pairs in the coordinate system, and wherein to calculate the path of the given vehicle, the autonomous vehicle control system further includes converting each (x, y) coordinate pair to a (l, r, θ) coordinate triple.

In still another additional embodiment, reconstructing the at least one remapped scenario includes converting each (l, r, θ) coordinate triple to an (x, y) coordinate pair in the target lane graph.

In a still further additional embodiment, the autonomous vehicle control system further includes steps for filtering the at least one remapped scenario to only include remapped scenarios where geometric values are held consistent with respect to the driving scenario.

In still another embodiment again, the search for subgraph isomorphisms further includes a search for approximate subgraph isomorphisms.

In a still further embodiment again, the autonomous vehicle control system further includes steps for encoding the at least one remapped scenario into a manifold, and training the autonomous vehicle control model includes providing the manifold to the autonomous vehicle control model.

One embodiment includes an autonomous vehicle training system including a processor, and a memory, the memory containing an autonomous vehicle training application that configures the processor to obtain a driving scenario, where the scenario describes at least a given vehicle trajectory on a given road network, generate a semantic representation of the given road network as a lane graph, calculate a path of the given vehicle through the lane graph, search for subgraph isomorphisms from the path to a target lane graph, where the target lane graph represents a target network having a different layout than the given road network, map the path to the target lane graph using the identified subgraph isomorphisms, reconstruct at least one remapped scenario using the mapped paths, and train an autonomous vehicle control model using the at least one remapped scenario.

In yet another additional embodiment, the scenario further describes trajectories of entities other than the given vehicle on the road network, and the autonomous vehicle training application further configures the processor to calculate a path for each of the entities through the lane graph, search for subgraph isomorphisms to the target lane graph from the paths of the entities, map the paths of the entities to their respective subgraph isomorphisms, and reconstruct the at least one remapped scenario using the respective subgraph isomorphisms.

In a yet further additional embodiment, the search for subgraph isomorphisms further includes a search for approximate subgraph isomorphisms.

One embodiment includes an autonomous vehicle control system that includes a lookup table constructed using remapped driving scenarios.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates an AV training system in accordance with an embodiment of the invention.

FIG. 2 is a block diagram for an AV trainer in accordance with an embodiment of the invention.

FIG. 3 is a flow chart for a synthetic scenario generation process in accordance with an embodiment of the invention.

FIG. 4 illustrates the conversion of a source road network into a source converted lane graph.

FIG. 5 illustrates an example (l, r, θ) coordinate triple in accordance with an embodiment of the invention.

FIG. 6 illustrates a subgraph of FIG. 4 in accordance with an embodiment of the invention.

FIG. 7 illustrates the conversion of a target road network into a target converted lane graph in accordance with an embodiment of the invention.

FIG. 8 illustrates a reconstructed scenario in accordance with an embodiment of the invention.

### DETAILED DESCRIPTION

Autonomous vehicles (AVs) have rapidly advanced in large part due to the generation of more complex neural networks. In order to train these neural networks, vast amounts of training data has been collected through the capture of driving records (i.e. sensor data, video data, etc.) from real world vehicle operation. However, when a car is operating, the vast majority of the time it will not encounter any “safety critical” scenarios: those in which the AV would need to turn sharply or break hard in order to avoid or mitigate a potential collision. These safety critical scenarios are edge cases, uncommon but high-risk situations that need to be handled by the AV. Even with the collection of huge amounts of driving records over more than a decade, the amount of safety critical scenario data is a small portion of the overall training corpus.

These rare, edge-case, safety critical scenarios are valuable, as they can be used to both train an AV to safely avoid an accident and validate that an AV is safe. Systems and methods for training AVs using edge cases to increase performance are discussed in U.S. patent application Ser. No. 17/649,330 titled “Systems and Methods for Autonomous Vehicle Control” filed Jan. 28, 2022, the entirety of which is hereby incorporated by reference. While in principle they could be generated synthetically, in practice it is difficult to find programmatic solutions that closely mirror human behavior. This has resulted in a dearth of safety critical training data that severely impacts the safety of current AV control models.

Therefore, it is important to maximize the value of any edge cases actually obtained from real life. To train an AV to consistently navigate a set of high risk scenarios, it is desirable to expose the AV to those cases on any possible location on which they could occur. Equivalently, to test that an AV can consistently navigate a set of failure cases, this same scenario remapping to other locations is desirable. That is, a driving record of a safety critical scenario is obtained with respect to a particular physical location and layout, e.g. a particular intersection or stretch of road. Remapping of the scenario refers to the application of the underlying situation to a different road and/or environmental configuration, e.g. scenario intersection mapped to a different intersection. In some cases, AV developers will have a particular operational design domain (ODD), which may be limited to a particular location or set of routes for an AV to drive in. In this case, the ability to remap scenarios to a particular location—targeting an existing road network in their ODD—is even more important, in order to make valuable scenarios obtained elsewhere relevant to their ODD.

To solve this technical challenge to autonomous vehicles, systems and methods for scenario remapping are described herein, wherein the relative positions and timings of road participants are transposed from a given road segment onto a multiplicity of other differently shaped roadways. In this way, the autonomous vehicle may be exposed to all scenarios that could happen on a given roadway it is obliged to navigate, not merely the ones observed there already. The resultant multiplicity of scenarios may be used to train the AV to adopt a generalized policy for handling high risk on each location. It may even be used in an explicit “look-up table,” wherein the AV can adopt an exact behavior that has been translated from a successful collision avoidance in a different location.

Techniques described herein overcome the limitations of earlier methods of the “abstract and re-generate” form. In these methods, a source scenario is analyzed and categorized into a logical description, and then that logical description is replayed on a different roadway in an attempt to create a similar scenario on a new roadway. Such an approach is limited by the fact that no semantic, logical or purely symbolic description has been able to capture the number of degrees of freedom of real-life driving behaviors. Colloquially speaking, the problem with these approaches is that a video is worth a million words.

Systems and methods described herein differ from these previous approaches as it starts from the fully realized source scenario and works directly on its geometric (x, y, z, h, p, r) coordinates, where h, p, r constitutes yaw, pitch and roll, respectively transforming and “warping” these to map from one location to another. In this way, the fine-details of the source scenario can be retained with far more confidence, since there is no requirement for a scenario abstraction and regeneration procedure that can recognize all the tiny but vital details of the source scenario. To achieve this, a “lane-relative” coordinate system and subgraph isomorphism algorithms are used to search for corresponding paths through a target road network. The source scenario can then be remapped to the target road network selecting the corresponding paths. These corresponding paths represent new scenarios that can be used for training an AV model. AV training systems that use scenario remapping for generating training data are described in further detail below, followed by additional discussion of scenario remapping processes.

### AV Training Systems

AV training systems can train AV models using scenario data. In many embodiments, AV training systems are implemented on any of a variety of distributed and/or remote (cloud) computing platforms. However, AV training systems can be implemented on local architectures as well. AV training systems can further include connections to third party systems, and in numerous embodiments, retrieve scenario data. In many embodiments, the AV training system generates and/or acquires synthetic scenarios via scenario remapping processes.

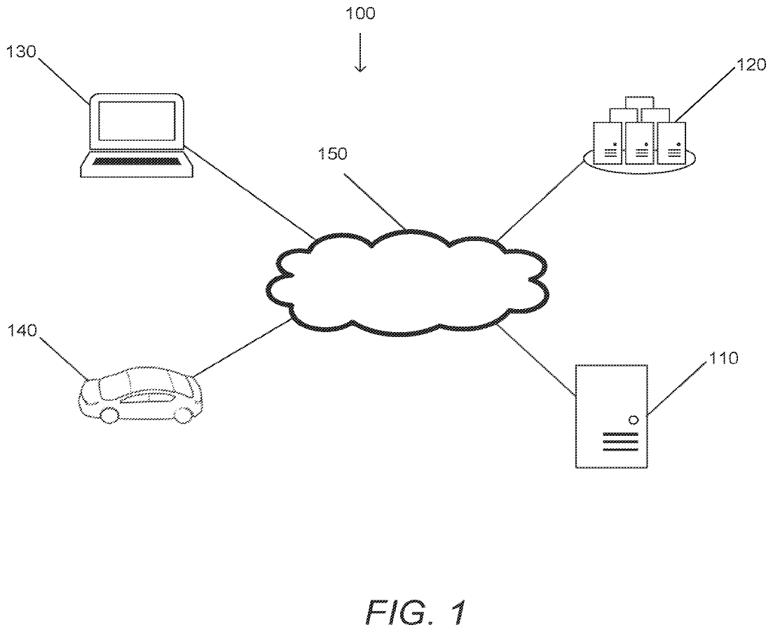

Turning now to FIG. 1, an AV training system in accordance with an embodiment of the invention is illustrated. System 100 includes an AV trainer 110. AV trainers can generate risk manifolds from graph databases and use them to train AV control models (also generally referred to herein as AVs). In numerous embodiments, the AV trainer generates synthetic scenarios. In various embodiments, a separate hardware component is used to generate synthetic scenarios which are obtained by the AV trainer. In additional embodiments, the AV trainer supplies an explicit policy for a vehicle's control in a given scenario. System 100 further includes data severs 120. Data servers can provide data desired by a user, which in turn can be encoded into a risk manifold. In numerous embodiments, data servers are third party servers which contain scenario data. Scenario data can include (but is not limited to) text descriptions, simulations, video, and/or any other encoding of an AV scenario in accordance with an embodiment of the invention. In some embodiments, third party servers include graph databases that contain the scenario data. In numerous embodiments, the data servers store synthetic scenarios.

System 100 further includes at least one display device 130. Display devices are devices which enable humans to interact with the system, such as, but not limited to, personal computers, tablets, smartphones, smart televisions, and/or any other computing device capable of enabling a human to interface with a computer system as appropriate to the requirements of specific applications of embodiments of the invention. In numerous embodiments, the display device and AV trainer are implemented using the same hardware.

System 100 includes AV platforms 140. AV platforms can be any number of vehicles which utilize AV models to control their autonomous operation. While the majority of the discussion herein is noted with respect to cars and trucks, as can readily be appreciated, example AV platforms can include (but are not limited to) cars, trucks, robotic systems, virtual assistants, and/or any other program or device that can incorporate an Al or ML system as appropriate to the requirements of specific applications of embodiments of the invention.

Components of system 100 are connected via a network 150. In numerous embodiments, the network is a composite network made of multiple different types of network. In many embodiments, the network includes wired networks and/or wireless networks. Different network components include, but are not limited to, the Internet, intranets, local area networks, wide area networks, peer-to-peer networks, and/or any other type of network as appropriate to the requirements of specific applications of embodiments of the invention. In various embodiments, AV models can be updated on AV platforms via a deployed update over the network. While an AV training system is described with respect to FIG. 1, any number of different systems can be architected in accordance with embodiments of the invention. For example, many embodiments may be implemented using a single computing platform. In a variety of embodiments, AV platforms are not connected via a network, and instead can be loaded with AV models prior to real-world deployment. As one of ordinary skill in the art can appreciate, many different configurations of AV training systems are possible in accordance with embodiments of the invention.

### AV Trainers

AV trainers are devices that can train AV models using risk manifolds. In numerous embodiments, AV trainers provide tool suites for manipulating, rendering, and utilizing risk manifolds. In a variety of embodiments, AV trainers are capable of generating risk manifolds from graph databases. In many embodiments, AV trainers include many or all of the capabilities of graph interface devices as described in U.S. Pat. No. 11,507,099 titled “Systems and Methods for Graph-Based AI Training”, filed September 2019, and granted Nov. 22, 2022, the entirety of which is hereby incorporated by reference in its entirety. AV trainers and AV training systems are additionally described in U.S. patent application Ser. No. 17/649,330, incorporated by reference and cited above.

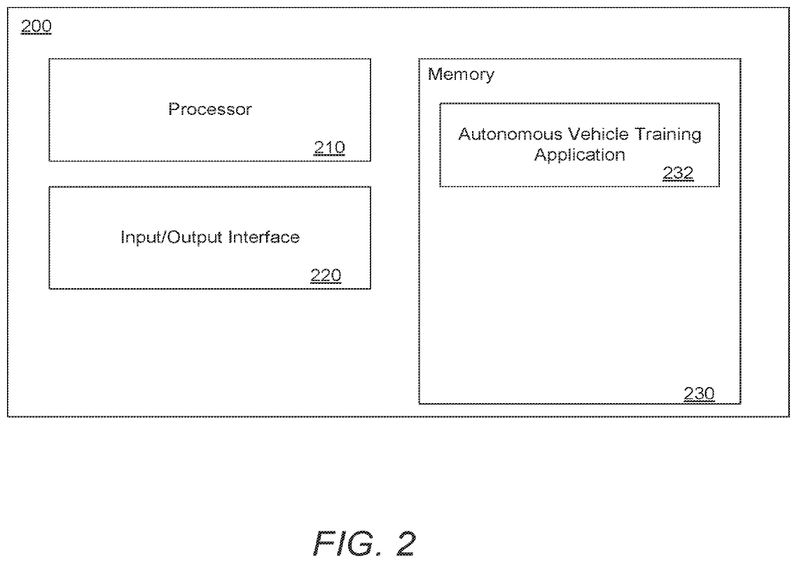

Turning now to FIG. 2, a conceptual block diagram of an AV trainer in accordance with an embodiment of the invention is illustrated. AV trainer 200 includes a processor 210. Processors can be any processing unit capable of performing logic calculations such as, but not limited to, central processing units (CPUs), graphics processing units (GPUs), application-specific integrated circuits (ASICs), field-programmable gate arrays (FPGAs), or any other processing device as appropriate to the requirements of specific applications of embodiments of the invention.

AV trainer 200 further includes an I/O interface 220. I/O interfaces can enable communication between the graph interface device, other components of an AV training system, and/or any other device capable of connection as appropriate to the requirements of specific applications of embodiments of the invention. AV trainer 200 further includes a memory 230. Memories can be any type of memory, such as volatile memory, non-volatile memory, or any mix thereof. In many embodiments, different memories are utilized within the same device. In a variety of embodiments, portions of the memory may be implemented externally to the device.

Memory 230 includes an AV training application 232. In a variety of embodiments, AV training applications direct the processor to carry out AV training processes as described herein, including the generation of synthetic scenarios for use in training.

While a specific implementation of an AV trainer is illustrated with respect to FIG. 2, any number of different architectures can be utilized as appropriate to the requirements of specific applications of embodiments of the invention. For example, different interfaces, numbers of processors, types of components, and/or additional or fewer stored data in memory can be utilized as appropriate to the requirements of specific applications of embodiments of the invention. Further, the generation of synthetic scenarios can be performed using separate computing hardware that may not be configured to carry out training of the model but is configured to generate the synthetic scenarios. In such a situation, the hardware may instead be referred to as a scenario generation device, configured similarly via scenario remapping application.

### Scenario Remapping Processes

As noted above, scenario remapping is a process by which synthetic scenarios are generated for the user in training AVs. In order to have significant value, synthetic scenarios generated by remapping should retain the features of the source scenario, but in a different environment, while maintaining viability as a real-life scenario. Indeed, the core challenge of scenario remapping is working with the geometric coordinates of the source scenario in such a way that allow enough flexibility—such that you can then map to a new location—but while keeping rigid (“fixed”) that which determines the “character” l interesting features of that scenario. One way of achieving this is by representing scenarios by reference to the “semantic” elements of the roadways on which they occur—particularly their connectivity—while discarding unnecessary geometric information. Then, if a new set of roadways can be found with a compatible semantic representation, the scenario can be mapped onto that location using the same representation.

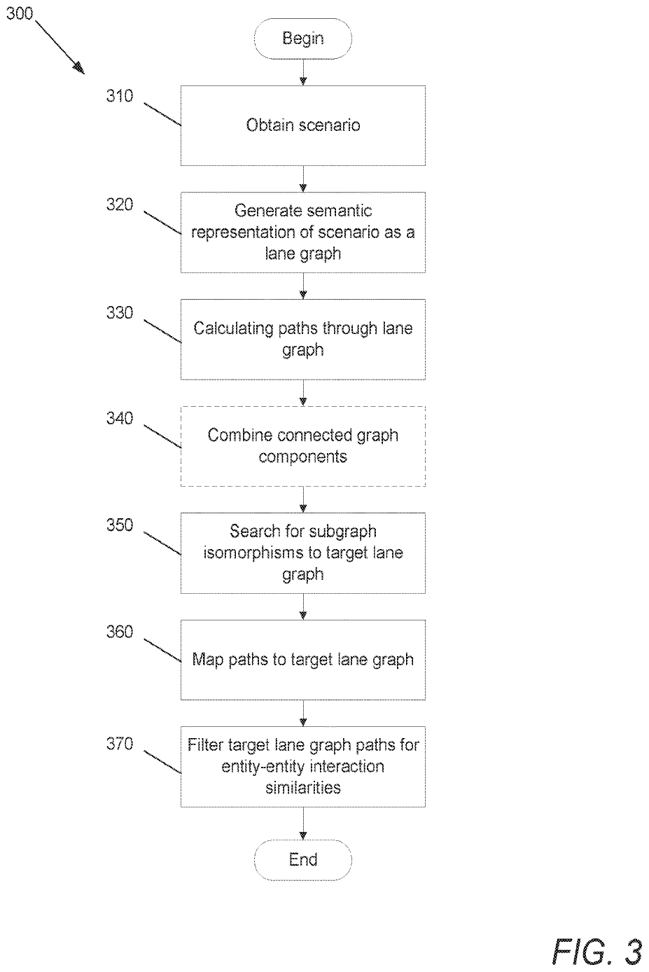

Turning now to FIG. 3, a flow chart for a scenario remapping process in accordance with an embodiment of the invention is illustrated. Process 300 includes obtaining (310) a scenario to be remapped. In many embodiments, the scenario is a description of entities on a particular roadway. In various embodiments, the scenario is generated from video data. However, text data such as insurance/police reports can be used to structurally generate a scenario.

A semantic representation of the lane connectivity underlying the scenario is generated (320) as a “lane graph”. This semantic/connectivity representation of a roadway is naturally achievable by representing it as a heterogeneous graph. Nodes are sampled along the centers of lanes, and successive nodes along the lane—and to possible connecting lanes—are denoted by (directed and labelled) successor edges. In this way, travelling along a particular lane is analogous to traversing a path of these nodes connected via successor edges. Nodes are also connected to nearby but otherwise unconnected nodes via (undirected) nearby edges. In this context, “unconnected” nodes are outside of a k-hop graph neighborhood of the source node, where k is a parameter to be determined. These nearby edges are required to capture all movements which are physically possible, not just those which are “legal”—this is extremely important if the aim is to represent edge cases. These edges are connected only to target nodes for whom their successor edges lie either in a very similar direction to the source node's successor edges—in which case they are connected via nearby same direction edges—or very dissimilar (~TT radians rotated)—in which case they are connected via nearby opposite direction edges. This way of encoding the drivable environment can be termed a “lane graph”, a term with precedent in the AV academic research. (E.g., Liang, Ming, et al. “Learning lane graph representations for motion forecasting.” Computer Vision-ECCV 2020: 16th European Conference, Glasgow, UK, Aug. 23-28, 2020, Proceedings, Part II 16. Springer International Publishing, 2020.)

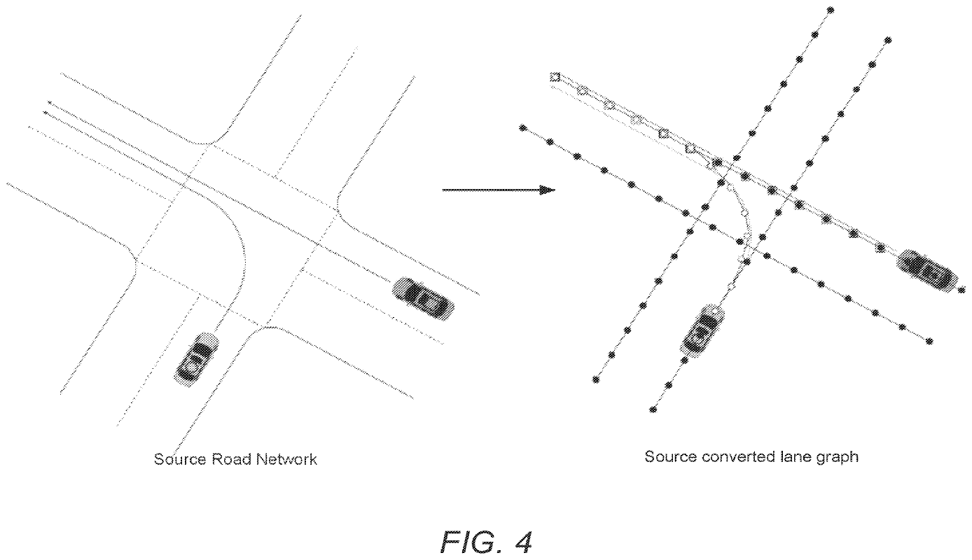

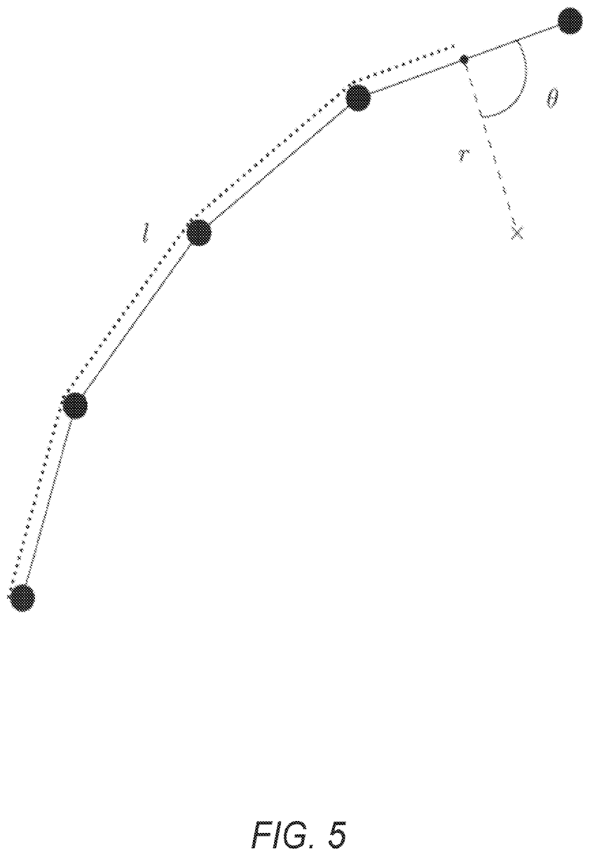

The movement (trajectories) of entities through this lane graph are represented as paths (ordered sequences of nodes, and the edges between them) through the graph, which can be encoded as part of the semantic representation of the scenario. These paths are calculated (330) based on the scenario data. FIG. 4 is diagram representing an example conversion of a road network to a lane graph, and the conversion of entity (here, two cars) motion to paths through the graph. In the illustrated example, the path of the left vehicle is denoted by nodes with a white center, and the right vehicle by nodes surrounded by squares. Note there are nodes which are contained within the paths of both vehicles, and some edges and possible paths are omitted for clarity. Trajectories are represented as a collection of (x, y) coordinate pairs; once a trajectory has been assigned a corresponding path through the graph (which is chosen to be as close as possible to the original trajectory while still representing a reasonable route through the graph), each (x, y) coordinate is converted into a (l, r, θ) coordinate triple. FIG. 5 is a diagram showing the conversion of an example (x, y) source coordinate into a (l, r, θ) coordinate triple. In FIG. 5, x represents the source coordinate, l is the length along the path to the point closest to the source coordinate. The point closest to the source coordinate is indicated by the small dot, the length along the path to that point is indicated by the dotted line. r is the distance from the closest point to the source coordinate. θ is the (signed) angle between the edge upon which the closest point lies and the source coordinate.

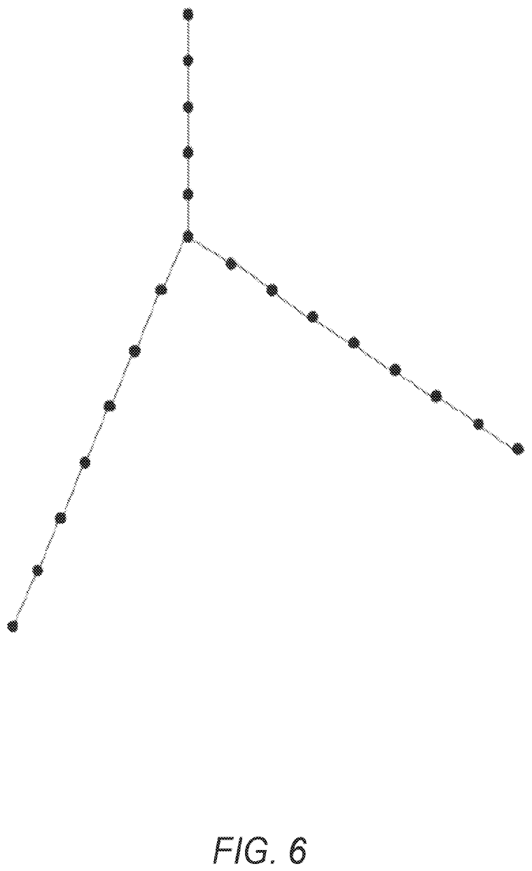

At this point, a scenario is represented by ordered lists of (l, r, θ) triples and graph paths. As an example, FIG. 6 illustrates the corresponding subgraph to FIG. 4. The edge-induced subgraph in FIG. 6 results from extracting the edges involved in the paths from FIG. 4, and is drawn without the shape of FIG. 4 as geometric information is not considered at this stage. Considered together, these graph paths represent an (edge-induced) subgraph of the original road network consisting of one or more connected components. In many embodiments, there can be additional processing steps here to reduce the number of connected components by combining (340) them, through adding in additional edges taken from the source lane graph. These edges could be successive successor edges to connect graphs if they occupy the same (or connected lanes), or they could be any of the nearby edges. In many embodiments, graphs are connected if it is possible to do so using only a few successor edges. This step of subgraph consolidation can be useful to reduce the search space of possible results at the end of the remapping process, but it is not necessary.

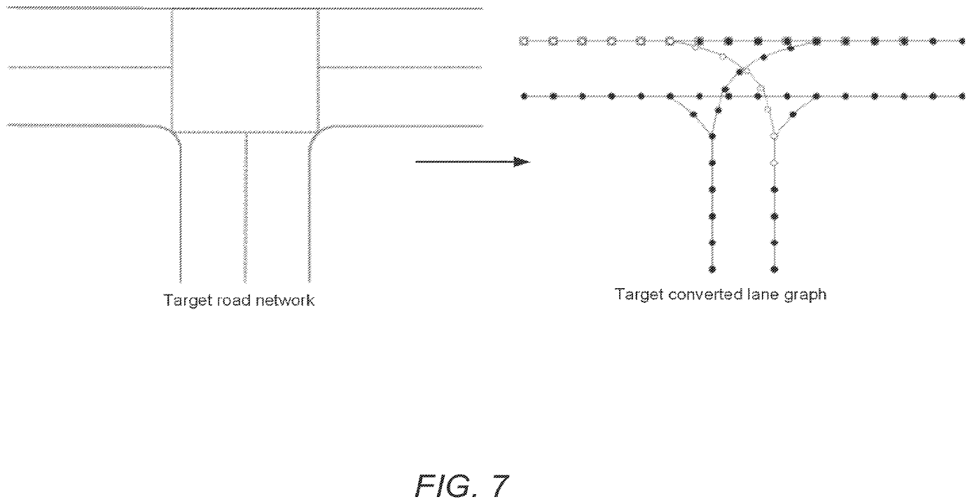

Any potential target road network can also be represented in the same lane graph form—this is shown for an example target road network in FIG. 7. The target road in FIG. 7 can be represented as a lane graph, and the converted lane graph highlights one possible set of nodes to which there is an exact isomorphism from FIG. 6. For each subgraph arising from the source lane graph, the target lane graph is searched (350) for subgraph isomorphisms to the target lane graph. Each connected component may have multiple isomorphisms, which quickly results in a combinatorial explosion. For n connected components with an average of m isomorphisms each, a naïve algorithm is expected to have a runtime that scales with O(mⁿ). In order to reduce the search space, any number of various methods can be employed such as computing subgraph isomorphism for each connected component separately, representing each target (isomorphic) connected component as just a single coordinate (its centroid), and (initially) optimizing only for distance to the connected component in which the ego vehicle (or equivalently, vehicle of most interest) can be found. By utilizing a k-d tree data structure, which has O(log n) search scaling, the runtime scaling can be reduced to O(nm log m).

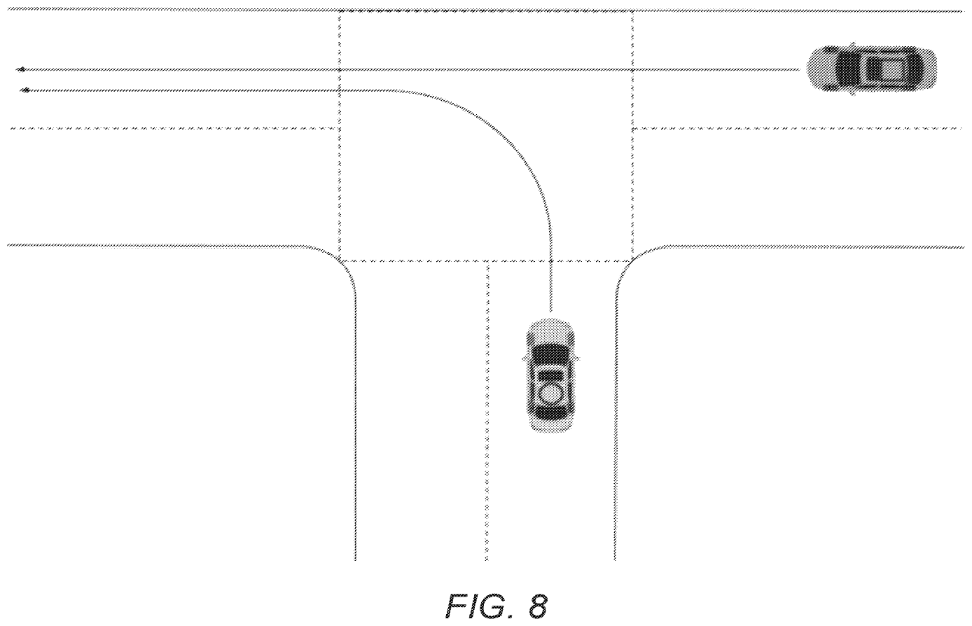

Once suitable (combinations of) isomorphisms have been found, each path through the source lane graph is mapped (360) to a path through the target lane graph. These new paths, and the same (l, r, θ) triples, can be converted back into (x, y) coordinates, thus creating the final “remapped” scenario. FIG. 8 illustrates a remapping of the scenario shown in FIG. 4 onto the target road network of FIG. 7.

Additional checks are applied to all of the remapped scenarios to filter (370) just those in which important geometric (particularly entity-entity interactions) values are held constant in the remapping process. The resulting set of remapped scenarios can then be integrated into the training corpus for an AV model. In various embodiments, they are encoded into a risk manifold for use in training. This process can be applied many times to remap any given scenario to any number of different target road networks to generate large amounts of training data.

Although specifics are discussed above, many different scenario generation methods can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for training an autonomous vehicle control system, comprising:
obtaining a driving scenario, where the scenario describes at least a given vehicle trajectory on a given road network;
generating a semantic representation of the given road network as a lane graph;
calculating a path of the given vehicle through the lane graph;
searching for subgraph isomorphisms from the path to a target lane graph, where the target lane graph represents a target network having a different layout than the given road network;
mapping the path to the target lane graph using the identified subgraph isomorphisms;
reconstructing at least one remapped scenario using the mapped paths; and
training an autonomous vehicle control model using the at least one remapped scenario.

2. The method of claim 1, wherein the scenario further describes trajectories of entities other than the given vehicle on the road network; and the method further comprises:
calculating a path for each of the entities through the lane graph;
searching for subgraph isomorphisms to the target lane graph from the paths of the entities;
mapping the paths of the entities to their respective subgraph isomorphisms; and
reconstructing the at least one remapped scenario using the respective subgraph isomorphisms.

3. The method of claim 2, further comprising combining one or more of the paths of the entities and the path of the given vehicle via connected components.

4. The method of claim 1, wherein the lane graph is a heterogenous graph comprising a plurality of nodes in a coordinate system connected by a plurality of edges, and the given vehicle trajectory is represented as a collection of (x, y) coordinate pairs in the coordinate system; and wherein to calculate the path of the given vehicle, the method further comprises converting each (x, y) coordinate pair to a (l, r, θ) coordinate triple.

5. The method of claim 4, wherein reconstructing the at least one remapped scenario comprises converting each (l, r, θ) coordinate triple to an (x, y) coordinate pair in the target lane graph.

6. The method of claim 1, further comprising filtering the at least one remapped scenario to only include remapped scenarios where geometric values are held consistent with respect to the driving scenario.

7. The method of claim 1, wherein the search for subgraph isomorphisms further comprises searching for approximate subgraph isomorphisms.

8. The method of claim 1, further comprising encoding the at least one remapped scenario into a manifold; and training the autonomous vehicle control model comprises providing the manifold to the autonomous vehicle control model.

9. The method of claim 1, further comprising loading the trained autonomous vehicle control model to an autonomous vehicle.

10. An autonomous vehicle control system, comprising:
a machine learning model trained using synthetic training data, where at least a portion of the synthetic training data is generated by:
obtaining a driving scenario, where the scenario describes at least a given vehicle trajectory on a given road network;
generating a semantic representation of the given road network as a lane graph;
calculating a path of the given vehicle through the lane graph;
searching for subgraph isomorphisms from the path to a target lane graph, where the target lane graph represents a target network having a different layout than the given road network;
mapping the path to the target lane graph using the identified subgraph isomorphisms;
reconstructing at least one remapped scenario using the mapped paths.

11. The autonomous vehicle control system of claim 10, wherein the scenario further describes trajectories of entities other than the given vehicle on the road network; and the training data is further generated by:
calculating a path for each of the entities through the lane graph;
searching for subgraph isomorphisms to the target lane graph from the paths of the entities;
mapping the paths of the entities to their respective subgraph isomorphisms; and
reconstructing the at least one remapped scenario using the respective subgraph isomorphisms.

12. The autonomous vehicle control system of claim 11, further comprising combining one or more of the paths of the entities and the path of the given vehicle via connected components.

13. The autonomous vehicle control system of claim 10, wherein the lane graph is a heterogenous graph comprising a plurality of nodes in a coordinate system connected by a plurality of edges, and the given vehicle trajectory is represented as a collection of (x, y) coordinate pairs in the coordinate system; and wherein to calculate the path of the given vehicle, the method further comprises converting each (x, y) coordinate pair to a (l, r, θ) coordinate triple.

14. The autonomous vehicle control system of claim 13, wherein reconstructing the at least one remapped scenario comprises converting each (l, r, θ) coordinate triple to an (x, y) coordinate pair in the target lane graph.

15. The autonomous vehicle control system of claim 10, further comprising filtering the at least one remapped scenario to only include remapped scenarios where geometric values are held consistent with respect to the driving scenario.

16. The autonomous vehicle control system of claim 10, wherein the search for subgraph isomorphisms further comprises a search for approximate subgraph isomorphisms.

17. The autonomous vehicle control system of claim 10, further comprising encoding the at least one remapped scenario into a manifold; and training the autonomous vehicle control model comprises providing the manifold to the autonomous vehicle control model.

18. An autonomous vehicle training system comprising:
a processor; and
a memory, the memory containing an autonomous vehicle training application that configures the processor to:
obtain a driving scenario, where the scenario describes at least a given vehicle trajectory on a given road network;
generate a semantic representation of the given road network as a lane graph;
calculate a path of the given vehicle through the lane graph;
search for subgraph isomorphisms from the path to a target lane graph, where the target lane graph represents a target network having a different layout than the given road network;
map the path to the target lane graph using the identified subgraph isomorphisms;
reconstruct at least one remapped scenario using the mapped paths; and
train an autonomous vehicle control model using the at least one remapped scenario.

19. The system of claim 18, wherein the scenario further describes trajectories of entities other than the given vehicle on the road network; and the autonomous vehicle training application further configures the processor to:
calculate a path for each of the entities through the lane graph;
search for subgraph isomorphisms to the target lane graph from the paths of the entities;
map the paths of the entities to their respective subgraph isomorphisms; and
reconstruct the at least one remapped scenario using the respective subgraph isomorphisms.

20. The system of claim 18, wherein the search for subgraph isomorphisms further comprises a search for approximate subgraph isomorphisms.
